(19) United States
(12) Patent Application Publication
(10) Pub. No.: US 2024/0370398 A1
(43) Pub. Date: Nov. 7, 2024

(54) UNIVERSAL INTERSYSTEM CONNECTION FOR A WEARABLE DISPLAY DEVICE

(71) Applicant: Meta Platforms Technologies, LLC, Menlo Park, CA (US)

(72) Inventor: Yin YANG, Palo Alto, CA (US)

(73) Assignee: Meta Platforms Technologies, LLC, Menlo Park, CA (US)

(21) Appl. No.: 18/312,971

(22) Filed: May 5, 2023

(51) Int. Cl. G06F 13/40; G06F 1/16; G06F 1/26

(52) U.S. Cl. CPC G06F 13/4081; G06F 1/163; G06F 1/266

(57) ABSTRACT

A system, device, and method for a universal intersystem connection are provided. In one aspect, a shielded twisted pair of wires electrically connects a first circuit board and a second circuit board in an apparatus, where the first and second circuit boards may communicate over the shielded twisted pair using differential signalling, and the first circuit board may also be powered by direct current (DC) power over the shielded twisted pair. In an example, the second circuit board is a controller of the first circuit board and may be electrically connected to a battery which powers the first circuit board via the shielded twisted pair. In other examples, a plurality of circuit boards may be electrically connected by the shielded twisted pair to a power source and may communicate with each other via differential signalling over shielded twisted pair.

### TECHNICAL FIELD

This patent application relates generally to providing a universal intersystem connection between components in a consumer device, and more specifically, to a connector, which provides both power and a communication link to the components in a wearable display device.

### BACKGROUND

With recent advances in technology, the prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers. To facilitate delivery of this and other related content, service providers have endeavored to provide various forms of wearable display systems. One such example may be a head-mounted display (HMD) device, such as a wearable eyewear, a wearable headset, or eyeglasses.

Wearable devices, such as augmented reality (AR) eyewear or glasses, smartwatches, handheld controllers, and similar ones may include any number of electrical components. Challenges with such wearable devices may include powering electrical components and providing for communication between electrical components, in light of the limited size and shape of such wearable devices.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1A illustrates a block diagram of a component subsystem connected by a shielded twisted pair to a controller subsystem with a battery, according to an example.

FIG. 1B illustrates a block diagram of component subsystems in a wearable display device being powered by at least one battery over a shielded twisted pair in a bus configuration, according to an example.

FIG. 2 illustrates a block diagram of an artificial reality system environment including a near-eye display device, according to an example.

FIG. 3 illustrates a perspective view of a near-eye display device in the form of a pair of glasses, where a shielded twisted pair is disposed in the near-eye display device, according to an example.

FIG. 4 illustrates a block diagram of a sensor circuit board connected to an application processor circuit board by a shielded twisted pair, according to an example.

FIG. 5 illustrates a flow diagram of a method for an application processor in a controller subsystem to provide communication and power over a single shielded twisted pair of wires in a near-eye display device, according to some examples.

FIG. 6 illustrates a flow diagram of a method for constructing an intersystem connection between circuit boards in a wearable display device, according to some examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

As used herein, a “wearable display device” may refer to any portable electronic device that may be worn on any body part of a user and used to present audio and/or video content, control other devices, monitor bodily functions, and perform similar actions. As used herein, a “near-eye display device” or “near-eye display” may refer to any display device (e.g., an optical device) that may be in close proximity to a user's eye. Accordingly, a near-eye display device or near-eye display may be a head-mounted display (HMD) device, such as a wearable eyewear, a wearable headset, and/or “smartglasses,” which may be used for interacting with virtual reality (VR), augmented reality (AR), and/or mixed reality (MR) environments, or any environment of real and virtual elements, such as a “metaverse.” As used herein, a “user” may refer to a user or wearer of a “near-eye display device,” “near-eye display,” and/or a “wearable display.”

In some examples, electronic components of a wearable display device may be connected by a shielded twisted pair of wires which may provide both power to, and a communication link between, the connected electronic components. In some examples, two electronic components may be directly connected by the shielded twisted pair, one of the electronic components may be the controller of the other, and the controller may also include a battery which powers the other electronic component. In some examples, the two electronic components may be directly connected to each other by two shielded twisted pairs of wires enabling full duplex communication. In some examples, a plurality of electronic components may be directly connected to each other by a plurality of shielded twisted pairs of wires. In other examples, a plurality of electronic components may be connected by a single shielded twisted pair of wires in a bus configuration.

While some advantages and benefits of the present disclosure are discussed herein, there are additional benefits and advantages which would be apparent to one of ordinary skill in the art.

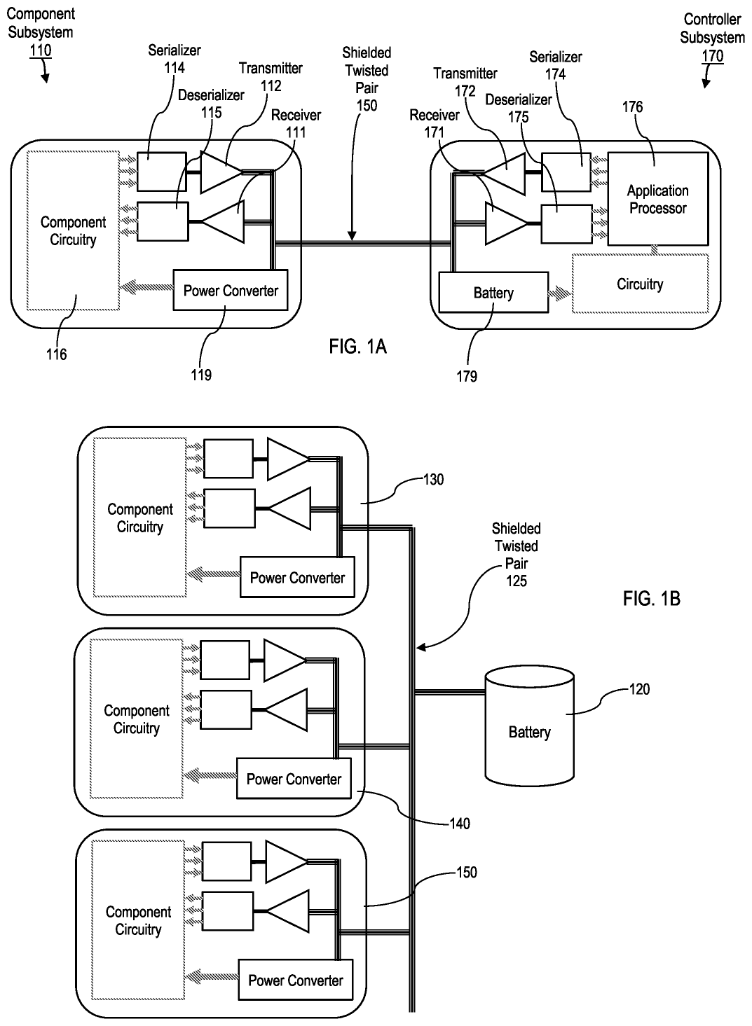

FIG. 1A illustrates a block diagram of a component subsystem connected by a shielded twisted pair to a controller subsystem with a battery, according to an example. As used herein in reference to the various examples, “component,” “subsystem,” “circuit ‘board,” “printed circuit board,” and/or like terms may be used interchangeably, as would be understood by one of ordinary skill in the art to refer to any operational separable part of a wearable display device which (1) may receive and/or transmit power, and (2) may receive or transmit communication signals (including, for example, data and control signals, which may include relatively simple signals, such as an ON/OFF signal).

As shown in FIG. 1A, a component subsystem 110 may be connected by a shielded twisted pair 150 to a controller subsystem 170, where the controller subsystem 170 both controls and provides power to the component subsystem 110 through the shielded twisted pair 150. In some examples, differential signalling is used by the controller subsystem 170 to communicate with the component subsystem 110 over the shielded twisted pair 150. Although the component subsystem 110 may be directly connected end-to-end to the controller subsystem 170 in FIG. 1A, subsystems in other examples may be connected via a shielded twisted pair to a bus-like network, as shown in FIG. 1B discussed below. In other examples, two or more shielded twisted pairs may be used for additional power/voltage and/or additional signalling capability between and among electrical components/subsystems and/or power sources. As used herein, “electronic subsystem” may be used to indicate any type of subsystem, including the component subsystem 110, the controller subsystem, and/or any other possible type of subsystem.

As would be understood by one of ordinary skill in the art, the shielded twisted pair 150 may have two separate electrical conductors wrapped around each other, i.e., twisted together, which supply direct current (DC) power to the electrical components in the wearable display device, as well as a “shield” common conductor layer covering the twisted pair. In some examples, the twisted pair of wires may be unshielded. In some examples, the shielded twisted pair 150 may transmit direct current (DC) power over its shielding conductor layer. In some examples, the shielding conductor layer of the shielded twisted pair 150 may serve as ground. In some examples, the individual wires within the shielded twisted pair 150 may have different voltages. For example, one of the wires in the shielded twisted pair may be at 3.1 volts while the other wire may be at 5 volts, and the shielding layer may act as ground.

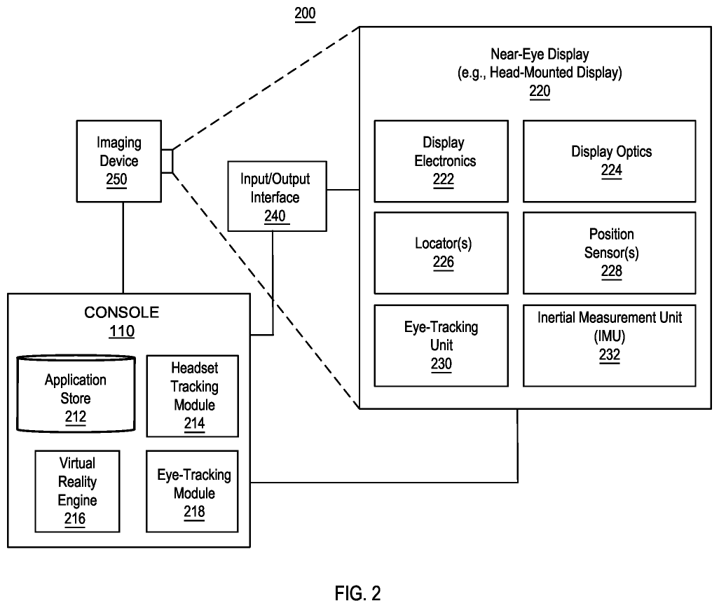

In some examples, the component subsystem 110 may include a receiver 111, a transmitter 112, a serializer 114, a deserializer 115, component circuitry 116, and a power converter 119. The component circuitry would depend on the type of subsystem, as would be known to one of ordinary skill in the art, including, for a wearable display device, an eye tracking system, a projector (such as, e.g., a laser or a scanning light source), an image sensor (such as, e.g., a camera), a position sensor (such as an accelerometer, a gyroscope, a magnetometer, etc.), an inertial measurement unit (IMU), a controller or processor, an input/output device, or display electronics, some of which are described in full detail below in reference to FIG. 2.

Similarly, in some examples, the controller subsystem 170 may include a receiver 171, a transmitter 172, a serializer 174, a deserializer 175, an application processor 176, and a battery 179, as well as other application-specific circuitry. In some examples, the receivers 111 and 171, the transmitters 112 and 172, the serializers 114 and 174, and the deserializers 115 and 175 may be constructed and function similarly, as discussed in greater detail below.

The battery 179, which is only in the controller subsystem 170, provides direct current (DC) power to the component subsystem 110 over the shielded twisted pair 150. The power converter 119, which is only in the component subsystem 110, receives the direct current (DC) power over the shielded twisted pair 150 and converts it for usage by the circuitry 116 of the component subsystem 110. In some examples, the power converter 119 may receive the direct current (DC) power over the shielding conductive layer of the twisted shielded pair 150. In some examples, the power converter 119 may be isolated from the differential signalling being transmitted for communication over the shielded twisted pair 150 using, for example, inductors.

The application processor 176, which is only in the controller subsystem 170, controls and communicates with component subsystem 110 using the shielded twisted pair 150. In some examples, the application processor 176 may include at least one processor and may be connected to at least one non-transitory computer-readable storage medium storing instructions executable by the at least one processor. The application processor 176 may include multiple processing units, and those multiple processing units may further execute instructions in parallel. The at least one non-transitory computer-readable storage medium may be any memory, such as a hard disk drive, a removable memory, or a solid-state drive (e.g., flash memory or dynamic random access memory (DRAM)).

In some examples, the communication circuits, i.e., the receivers 111 and 171 and the transmitters 112 and 172, are all electrically connected to the shielded twisted pair 150 over which they communicate using differential signalling. In some examples, the communication circuits, i.e., the receivers 111 and 171 and the transmitters 112 and 172, may need to be effectively isolated from the direct current (DC) power voltage being transmitted over the shielded twisted pair 150. In some examples, capacitors may be used to isolate the communication circuits.

In some examples, differential signalling is used to communicate over the shielded twisted pair 150. In such examples, a complementary pair of signals (i.e., having opposite polarity) are transmitted over the two separate wires in the shielded twisted pair 150, thereby enabling binary signalling (i.e., only one of two symbols may be transmitted at a time, commonly a 1 or a 0). In such examples, when a communication symbol, in the form of a pair of complementary signals, is received over the shielded twisted pair 150, the receiver(s) 111/171 may effectively turn the received pair of complementary signals into a 1 or a 0, which may be provided as part of a series of symbols to the deserializer(s) 115/175, which may convert the series of received symbols into a parallel order and/or construction, i.e., either back into the parallel streams of data originally transmitted, and/or possibly into parallel constructions such as, e.g., bytes, words, or other like unit of communication, which were used in an original single stream of data which was transmitted.

In some examples, the deserializer(s) 115/175 may convert a serial stream received over the shielded twisted pair 150 into parallel data streams to be distributed internally within its subsystem. For instance, the deserializer 115 may convert a serial stream (output by the receiver 111) received over the shielded twisted pair 150 into parallel data streams to be distributed to different subcomponents within the component circuitry 116 of the component subsystem 110, and the deserializer 175 may convert a serial stream (output by the receiver 171) received over the shielded twisted pair 125 into parallel data streams for the application processor 176 of the controller subsystem 170.

Similarly, when a communication, in the form of, e.g., bytes, words, and/or parallel steams of data, is to be transmitted by either the component subsystem 110 or the controller subsystem 170, it may first be serialized by serializers 114/174 into a series of individual symbols, most commonly depicted as binary 0 and 1, and each symbol may be transmitted by the transmitters 111/172 over the wires of the shielded twisted pair 150 in the form of a complementary pair of signals for each symbol. For instance, the serializer 114 may convert parallel data streams received from the component circuitry 116 of the component subsystem 110 into a serial stream for the transmitter 112 to transmit over the shielded twisted pair 150, and the serializer 174 may convert parallel data streams received from the application processor 176 of the controller subsystem 170 into a serial stream for the transmitter 172 to transmit over the shielded twisted pair 150.

As would be understood by one of ordinary skill in the art, the serializers 114/174 and the deserializers 115/175 performing the serialization and deserialization (SERDES or SerDes) function in FIG. 1A may be implemented using a wide variety of techniques in a wide variety of hardware. A simple implementation may be a shift register. In some examples, a reference clock and timing signals may be used for the serialization and deserialization (SERDES or SerDes) and/or the differential signalling over the shielded twisted pair 150. In other examples, more complex techniques/implementations may be employed, such as, for example, the serialization and deserialization (SERDES or SerDes) electrical interfaces defined by the Common Electrical Input/Output (CEI) standards of the Optical Internetworking Forum (OIF). In other examples, a serialization and deserialization (SERDES or SerDes) scheme such as shown in FIG. 1A is not used, and/or no internal clock or timing signals are used.

In some examples, the transmitters 112/172 and the receivers 111/171 may take the form of amplifiers, where the receivers 111/171 may receive a complementary pair of signals (representing one symbol) over the two wires in the shielded twisted pair 150 via a positive input and a negative input, and, similarly, the transmitters 112/172 may transmit a complementary pair of signals (representing one symbol) over the two wires in the shielded twisted pair 150 via a positive output and a negative output. In such examples, the transmitters 112/172 may transmit one voltage on the positive output and an inverted form of that voltage on the negative output. For instance, if the supply voltage is Vs, the symbol 1 may be represented by a positive Vs, which, when received from the serializers 114/174, the transmitters 112/172 would amplify and transmit as the complementary pair +Vs and −Vs over the two wires in the shielded twisted pair 150. In like manner, when the complementary pair +Vs and −Vs is received over the shielded twisted pair 150 by the positive input and the negative input, respectively, of the receivers 111/171, the receivers 111/171 amplify the +Vs and −(−Vs) in order to output +2 Vs, which may be recognized as the symbol 1.

Similarly, the symbol 0 may be represented by a negative Vs, which, when received from the serializers 114/174, the transmitters 112/172 would amplify and transmit as the complementary pair −Vs and +Vs over the shielded twisted pair 150. In like manner, when the complementary pair −Vs and +Vs is received over the shielded twisted pair 150 by the positive input and the negative input, respectively, of the receivers 111/171, the receivers 111/171 would amplify the −Vs and −(+Vs) in order to output −2 Vs, which may be recognized as the symbol 0. As would be understood by one of ordinary skill in the art, this is only one specific implementation, and a wide variety of other techniques and implementations of differential signalling are possible in accordance with examples of the present disclosure.

The particular circuitry for implementing examples according to the present disclosure may vary according to the needs and requirements of the specific wearable display device, as would be understood by one of ordinary skill in the art, and may use any of a wide variety of techniques and technologies, including, for example, differential emitter-coupled logic (ECL), positive or pseudo-emitter-coupled logic (PECL), low voltage positive emitter-coupled logic (LVPECL), metal oxide semiconductor (MOS) current mode logic (MCML) (in which, e.g., the transmitters 112/172 and the receivers 111/171 may be implemented as differential amplifiers), etc.

As would be understood by one of ordinary skill in the art, a communication protocol may be needed for negotiating the shared single communication link over the shielded twisted pair 150. In some examples, a multiple access protocol may be employed such as time division multiple access, where, assuming a common clock signal, each component might have its own time slot to transmit a signal, or even more complicated schemes, such as, for example, carrier-sense multiple access with collision detection (CSMA/CD), carrier-sense multiple access with collision avoidance (CSMA/CA), or any of the many other forms of duplexing/multiplexing over a single communication link, as would be understood by one of ordinary skill in the art. Communication protocols for differential pairs carrying differential signals (i.e., a complementary pair of signals) and/or semi-differential signals are known to one of ordinary skill in the art and include the following, which are not cited for their specific electrical parameters (i.e., voltages, speed, plugs, conductive material, etc.), but rather to show the variety of possible communication protocols using a twisted pair of wires or something like a twisted pair of wires as a sole communication link: low voltage differential signalling (LVDS) also known as the standard Telecommunications Industry Association (TIA)/EIA-644, as well as RS-422, RS-485, Serial Digital Interface (SDI), Serial AT Attachment (SATA), FireWire, transmission-minimized differential signalling (TMDS), Ethernet over twisted pair, etc.

In examples like FIG. 1A where the shielded twisted pair 150 is connecting only one electrical component directly to another electrical component, a communication protocol suitable for when only a single communication link may be used for both transmission and reception by both electrical components. For instance, such an example may use a signalling protocol similar to the Universal Serial Bus (USB), which also uses differential signalling over a twisted pair.

In other examples, two shielded twisted pairs may connect the component subsystem 110 and the controller subsystem 170 rather than the single shielded twisted pair 150 in FIG. 1A, thereby enabling full duplex communication between two electrical components/subsystems. In such examples, each of the two shielded twisted pairs may be connected only to a transmitter at one end with only a receiver at the other end. Similarly, multiple shielded twisted pairs may connect the controller subsystem 170 to multiple subsystems.

FIG. 1B illustrates a block diagram of component subsystems in a wearable display device being powered by at least one battery over a shielded twisted pair in a bus configuration, according to an example. In FIG. 1B, a battery 120 may supply power in the form of a direct current (DC) over a shielded twisted pair cable or wire 125 to at least a first component subsystem 130, a second component subsystem 140, and a third component subsystem 150. There may be additional component subsystems being supplied power by battery 120 over the shielded twisted pair 125, and additional batteries or other power sources supplying power over the shielded twisted pair 125.

As shown in FIG. 1B, the shielded twisted pair 125 may act as a bus connecting all of the component subsystems and all of the power supplies. This is the most generalized example of the present disclosure, as the shielded twisted pair may simply connect two subsystems, like the twisted shielded pair 150 in FIG. 1A above. As would be understood by one of ordinary skill in the art, using the shielded twisted pair 125 in a bus configuration would require the cable/wire forming the shielded twisted pair 125 to form many electrical connections rather than simply two (one at each end of the cable/wire). In one instance, this may be implemented by a simple daisy chain of shielded twisted pair links connecting each electrical component to the next.

In some examples, the shielded twisted pair 125 may include two or more shielded twisted pairs, which would allow for greater bandwidth communication as well as full duplex and/or multiplex communication between component subsystems. In such examples, a bus configuration, such as is shown in FIG. 1B, may not be needed, as direct, end-to-end connections may be created by each shielded twisted pair. In some examples, the component subsystems, such as the first, second, and third component subsystems 130, 140, and 150, may be individual printed circuit boards serving different functions within a wearable display device. In some examples, the battery 120 may be disposed within a component subsystem, such as, for example, within at least one of the first, second, and third component subsystems 130, 140, and 150, or the battery 120 may include multiple batteries, where each, all, or some are disposed within one or more component subsystems.

In examples such as shown in FIG. 1B, data communication between the component subsystems may be transmitted through the shielded twisted pair 125 which also may be supplying direct current (DC) power to the component subsystems. In some examples, differential signalling using the two separate wires in the shielded twisted pair 125 may be used to communicate between the component subsystems.

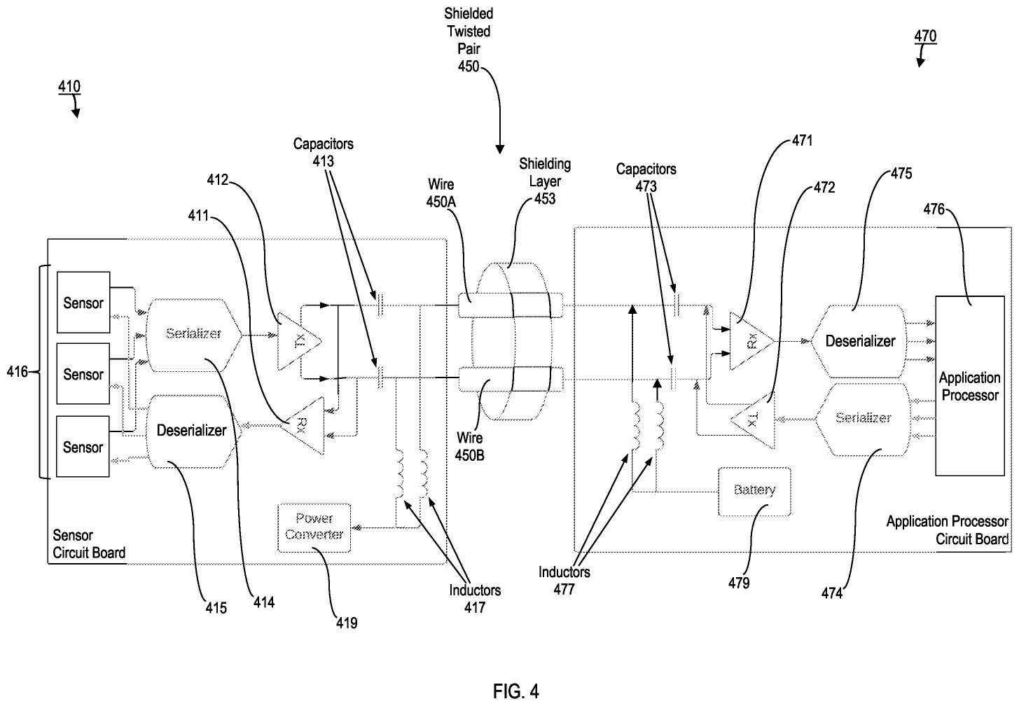

As shown in FIG. 1B, each of the component subsystems may have similar parts connecting with the shielded twisted pair 125. For example, in the first component subsystem 130, the shielded twisted pair 125 may be connected to both the communication circuits to and from the component circuitry in the first component subsystem 130 and to the power converter for supplying power to the component circuitry in the first component subsystem 130. Such separation of power from communications in the first component subsystem 130 may be implemented by a large variety of techniques, as would be understood by one of ordinary skill in the art. One example is shown in FIG. 4, discussed below.

As shown in FIG. 1B, the second component subsystem 140 has similar parts as the first component subsystem 130 for connecting with the shielded twisted pair 125, i.e., communication circuits and a power converter, but the second component subsystem 140 may be of a completely different type, serving a completely different function or purpose than the first component subsystem 130. For example, the first component subsystem 130 may be display electronics while the second component subsystem 140 may be a camera. As shown in FIG. 1B, the remaining third component subsystem 150 has similar parts for communicating and receiving power over the shielded twisted pair 125. In some examples, the component subsystems 130, 140, and 150 may be in a head-mounted display (HMD), and may be any one of, or a part of, for example, an eye tracking system, a projector (such as, e.g., a laser or a scanning light source), an image sensor (such as, e.g., a camera), a position sensor (such as, e.g. an accelerometer, a gyroscope, a magnetometer, etc.), an inertial measurement unit (IMU), a controller or processor, an input/output device, or display electronics.

In some examples, the shielded twisted pair 125 may act as a common bus for communication between the electrical components. As would be understood by one of ordinary skill in the art, sharing a common bus for communication may require an appropriate communication protocol for sharing a single communication link. In some examples, carrier-sense multiple access with collision detection (CSMA/CD), such as used by Ethernet, carrier-sense multiple access with collision avoidance (CSMA/CA), or any of the many other forms of duplexing/multiplexing over a single communication link may be employed, as would be understood by one of ordinary skill in the art.

FIG. 2 illustrates a block diagram of an artificial reality system environment 200 including a near-eye display device, according to an example. As used herein, a “near-eye display device” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display device.”

As shown in FIG. 2, the artificial reality system environment 200 may include a near-eye display device 220, an optional external imaging device 250, and an optional input/output interface 240, each of which may be coupled to a console 210. The console 210 may be optional in some instances as the functions of the console 210 may be integrated into the near-eye display device 220. In some examples, the near-eye display device 220 may be a head-mounted display (HMD) that presents content to a user.

In some instances, for a near-eye display device system, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). Also, as used herein, an “eye box” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eye box.

In some examples, the near-eye display device 220 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

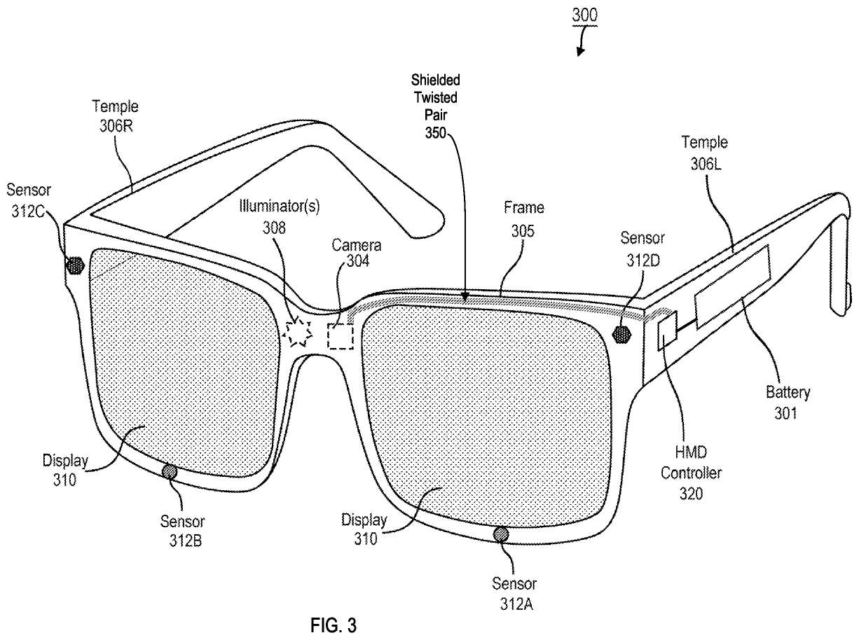

In some examples, the near-eye display device 220 may be implemented in any suitable form-factor, including a head-mounted display (HMD), a pair of glasses, or other similar wearable eyewear or device. An example of the near-eye display device 220 are further described below with respect to FIG. 3. Additionally, in some examples, the functionality described herein may be used in a head-mounted display (HMD) or headset that may combine images of an environment external to the near-eye display device 220 and artificial reality content (e.g., computer-generated images). Therefore, in some examples, the near-eye display device 220 may augment images of a physical, real-world environment external to the near-eye display device 220 with generated and/or overlaid digital content (e.g., images, video, sound, etc.) to present an augmented reality to a user.

In some examples, the near-eye display device 220 may include any number of display electronics 222, display optics 224, and an eye-tracking unit 230. In some examples, the near-eye display device 220 may also include one or more locators 226, one or more position sensors 228, and an inertial measurement unit (IMU) 232. In some examples, the near-eye display device 220 may omit any of the eye-tracking unit 230, the one or more locators 226, the one or more position sensors 228, and the inertial measurement unit (IMU) 232, or may include additional elements.

In some examples, the display electronics 222 may display or facilitate the display of images to the user according to data received from, for example, the optional console 210. In some examples, the display electronics 222 may include one or more display panels. In some examples, the display electronics 222 may include any number of pixels to emit light of a predominant color such as red, green, blue, white, or yellow. In some examples, the display electronics 222 may display a three-dimensional (3D) image, e.g., using stereoscopic effects produced by two-dimensional panels, to create a subjective perception of image depth.

In some examples, the near-eye display device 220 may include a projector (not shown), which may form an image in angular domain for direct observation by a viewer's eye through a pupil. The projector may employ a controllable light source (e.g., a laser source) and a micro-electromechanical system (MEMS) beam scanner to create a light field from, for example, a collimated light beam. The micro-electromechanical system (MEMS) beam scanner may “paint” the image on an eye box following a biresonant coherent Lissajous pattern. Emitters of a multi-ridge light source may be aligned horizontally, vertically, or at an arbitrary angle with more than one pixel ridge separation. Static uniformity errors may be corrected through computation of correction factors for pulse events for each frame by analytical or optimization techniques.

In some examples, the display optics 224 may display image content optically (e.g., using optical waveguides and/or couplers) or magnify image light received from the display electronics 222, correct optical errors associated with the image light, and/or present the corrected image light to a user of the near-eye display device 220. In some examples, the display optics 224 may include a single optical element or any number of combinations of various optical elements as well as mechanical couplings to maintain relative spacing and orientation of the optical elements in the combination. In some examples, one or more optical elements in the display optics 224 may have an optical coating, such as an anti-reflective coating, a reflective coating, a filtering coating, and/or a combination of different optical coatings.

In some examples, the display optics 224 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 226 may be objects located in specific positions relative to one another and relative to a reference point on the near-eye display device 220. In some examples, the optional console 210 may identify the one or more locators 226 in images captured by the optional external imaging device 250 to determine the artificial reality headset's position, orientation, or both. The one or more locators 226 may each be a light-emitting diode (LED), a corner cube reflector, a reflective marker, a type of light source that contrasts with an environment in which the near-eye display device 220 operates, or any combination thereof.

In some examples, the external imaging device 250 may include one or more cameras, one or more video cameras, any other device capable of capturing images including the one or more locators 226, or any combination thereof. The optional external imaging device 250 may be configured to detect light emitted or reflected from the one or more locators 226 in a field of view of the optional external imaging device 250.

In some examples, the one or more position sensors 228 may generate one or more measurement signals in response to motion of the near-eye display device 220. Examples of the one or more position sensors 228 may include any number of accelerometers, gyroscopes, magnetometers, and/or other motion-detecting or error-correcting sensors, or any combination thereof.

In some examples, the inertial measurement unit (IMU) 232 may be an electronic device that generates fast calibration data based on measurement signals received from the one or more position sensors 228. The one or more position sensors 228 may be located external to the inertial measurement unit (IMU) 232, internal to the inertial measurement unit (IMU) 232, or any combination thereof. Based on the one or more measurement signals from the one or more position sensors 228, the inertial measurement unit (IMU) 232 may generate fast calibration data indicating an estimated position of the near-eye display device 220 that may be relative to an initial position of the near-eye display device 220. For example, the inertial measurement unit (IMU) 232 may integrate measurement signals received from accelerometers over time to estimate a velocity vector and integrate the velocity vector over time to determine an estimated position of a reference point on the near-eye display device 220. Alternatively, the inertial measurement unit (IMU) 232 may provide the sampled measurement signals to the optional console 210, which may determine the fast calibration data.

The eye-tracking unit 230 may include one or more eye-tracking systems. As used herein, “eye tracking” may refer to determining an eye's position or relative position, including orientation, location, and/or gaze of a user's eye. In some examples, an eye-tracking system may include an imaging system that captures one or more images of an eye and may optionally include a light emitter, which may generate light that is directed to an eye such that light reflected by the eye may be captured by the imaging system. In other examples, the eye-tracking unit 230 may capture reflected radio waves emitted by a miniature radar unit. These data associated with the eye may be used to determine or predict eye position, orientation, movement, location, and/or gaze.

In some examples, the near-eye display device 220 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye-tracking unit 230 may be able to determine where the user is looking or predict any user patterns, etc.

In some examples, the input/output interface 240 may be a device that allows a user to send action requests to the optional console 210. As used herein, an “action request” may be a request to perform a particular action. For example, an action request may be to start or to end an application or to perform a particular action within the application. The input/output interface 240 may include one or more input devices. Example input devices may include a keyboard, a mouse, a game controller, a glove, a button, a touch screen, or any other suitable device for receiving action requests and communicating the received action requests to the optional console 210. In some examples, an action request received by the input/output interface 240 may be communicated to the optional console 210, which may perform an action corresponding to the requested action.

In some examples, the optional console 210 may provide content to the near-eye display device 220 for presentation to the user in accordance with information received from one or more of external imaging device 250, the near-eye display device 220, and the input/output interface 240. For example, in the example shown in FIG. 2, the optional console 210 may include an application store 212, a headset tracking module 214, a virtual reality engine 216, and an eye-tracking module 218. Some examples of the optional console 210 may include different or additional modules than those described in conjunction with FIG. 2. Functions further described below may be distributed among components of the optional console 210 in a different manner than is described here.

In some examples, the optional console 210 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 210 described in conjunction with FIG. 2 may be encoded as instructions in the non-transitory computer-readable storage medium that, when executed by the processor, cause the processor to perform the functions further described below. It should be appreciated that the optional console 210 may or may not be needed or the optional console 210 may be integrated with or separate from the near-eye display device 220.

In some examples, the application store 212 may store one or more applications for execution by the optional console 210. An application may include a group of instructions that, when executed by a processor, generates content for presentation to the user. Examples of the applications may include gaming applications, conferencing applications, video playback application, or other suitable applications.

In some examples, the headset tracking module 214 may track movements of the near-eye display device 220 using slow calibration information from the external imaging device 250. For example, the headset tracking module 214 may determine positions of a reference point of the near-eye display device 220 using observed locators from the slow calibration information and a model of the near-eye display device 220. Additionally, in some examples, the headset tracking module 214 may use portions of the fast calibration information, the slow calibration information, or any combination thereof, to predict a future location of the near-eye display device 220. In some examples, the headset tracking module 214 may provide the estimated or predicted future position of the near-eye display device 220 to the virtual reality engine 216.

In some examples, the virtual reality engine 216 may execute applications within the artificial reality system environment 200 and receive position information of the near-eye display device 220, acceleration information of the near-eye display device 220, velocity information of the near-eye display device 220, predicted future positions of the near-eye display device 220, or any combination thereof from the headset tracking module 214. In some examples, the virtual reality engine 216 may also receive estimated eye position and orientation information from the eye-tracking module 218. Based on the received information, the virtual reality engine 216 may determine content to provide to the near-eye display device 220 for presentation to the user.

In some examples, the eye-tracking module 218 may receive eye-tracking data from the eye-tracking unit 230 and determine the position of the user's eye based on the eye tracking data. In some examples, the position of the eye may include an eye's orientation, location, or both relative to the near-eye display device 220 or any element thereof. So, in these examples, because the eye's axes of rotation change as a function of the eye's location in its socket, determining the eye's location in its socket may allow the eye-tracking module 218 to more accurately determine the eye's orientation.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

In examples according to the present disclosure, a shielded twisted pair may be used to connect one or more head-mounted display (HMD) controllers in the near-eye display device 220 to any of the display electronics 222, the display optics 224, the locator(s) 226, the position sensor(s) 228, the eye-tracking unit 230, and the inertial measurement unit (IMU) 232. In some examples, a shielded twisted pair may be used in a bus configuration to share both power and communications among one or more components in the near-eye display device 220 including, but not limited to, the display electronics 222, the display optics 224, the locator(s) 226, position sensor(s) 228, the eye-tracking unit 230, and the inertial measurement unit (IMU) 232. In other examples, multiple shielded twisted pairs may interconnect one or more components in the near-eye display device 220 including, but not limited to, the display electronics 222, the display optics 224, the locator(s) 226, position sensor(s) 228, the eye-tracking unit 230, and the inertial measurement unit (IMU) 232.

FIG. 3 illustrates a perspective view of a near-eye display device in the form of a pair of glasses, where a shielded twisted pair is disposed in the near-eye display device, according to an example. While the example shown in FIG. 3 is a near-eye display device in the form of a pair of glasses, other examples may be other forms of head-mounted display (HMD) devices or other wearable display devices.

In some examples, the near-eye display device 300 may include a frame 305, right and left temples 306R and 306L, respectively, and a display 310. The display 310 may be configured to present media or other content to a user, or may be configured to operate as a virtual reality (VR) display, an augmented reality (AR) display, and/or a mixed reality (MR) display. The display 310 may include display electronics and/or display optics. For example, the display 310 may include a transparent liquid crystal display (LCD) display panel, a transparent light-emitting diode (LED) display panel, or a transparent optical display panel (e.g., a waveguide display assembly). Other optical components may include waveguides, gratings, lenses, mirrors, etc. Electrical components may include sensors 312A-312D, camera 304, illuminator(s) 308, etc.

In some examples, the various sensors 312A-312D may include any number of depth sensors, motion sensors, position sensors, inertial sensors, and/or ambient light sensors, as shown. In some examples, the various sensors 312A-312D may include any number of image sensors configured to generate image data representing different fields of views in one or more different directions. In some examples, the various sensors 312A-312D may be used as input devices to control or influence the displayed content of the near-eye display device 300, and/or to provide an interactive virtual reality (VR), augmented reality (AR), and/or mixed reality (MR) experience to a user of the near-eye display device 300. In some examples, the various sensors 312A-312D may also be used for stereoscopic imaging or other similar application. A virtual reality engine (implemented on the near-eye display device 300 or on another computing device and wirelessly connected to the near-eye display device 300) may execute applications within the near-eye display device 300 and receive depth information, position information, acceleration information, velocity information, predicted future positions, or any combination thereof of the near-eye display device 300 from the various sensors 312A-312D.

In some examples, the near-eye display device 300 may further include one or more illuminator(s) 308 to project light into a physical environment. The projected light may be associated with different frequency bands (e.g., visible light, infra-red light, ultra-violet light, etc.), and may serve various purposes. In some examples, the one or more illuminator(s) 308 may be used as locators, which may be detectable by an external imaging device. This may be useful for the purposes of head tracking or other movement/orientation. It should be appreciated that other elements or components may also be used in addition or in lieu of such locators.

In some examples, the near-eye display device 300 may also include a camera 304 or other image capture unit as an image sensor. The camera 304, for instance, may capture images of the physical environment in the field of view. In some instances, the captured images may be processed, for example, by a virtual reality engine (implemented on the near-eye display device 300 or on another computing device and wirelessly connected to the near-eye display device 300) to add virtual objects to the captured images or modify physical objects in the captured images, and the processed images may be displayed to the user by the display 310 for augmented reality (AR) and/or mixed reality (MR) applications.

In some examples, the near-eye display device 300 may be implemented in any suitable form-factor, in addition to the pair of glasses shown in the figure, such as a head-mounted display (HMD) or other similar wearable eyewear or device. The near-eye display device 300 may also include (not shown) one or more eye-tracking systems. As used herein, “eye tracking” may refer to determining an eye's position or relative position, including orientation, location, and/or gaze of a user's eye.

In examples according to the present disclosure, the near-eye display device 300 may include a head-mounted display (HMD) controller 320 connected to a battery 301. As shown in FIG. 3, the head-mounted display (HMD) controller 320 and the battery 301 may be incorporated into the left temple 306L of near-eye display device 300. In other examples, the head-mounted display (HMD) controller 320 and the battery 301 may be disposed in other locations in the near-eye display device 300. As shown in FIG. 3, the head-mounted display (HMD) controller 320 and the battery 301 may be connected and the battery 301 may provide power to the head-mounted display (HMD) controller 320.

In some examples, the head-mounted display (HMD) controller 320 may control one, more, or all of the components in the near-eye display device 300. For example, the head-mounted display (HMD) controller 320 may be the virtual reality engine referred to above. In some examples, the head-mounted display (HMD) controller 320 may include a processor and at least one non-transitory computer-readable storage medium storing instructions executable by the processor. The processor may include multiple processing units, and those multiple processing units may further execute instructions in parallel. The at least one non-transitory computer-readable storage medium may be any memory, such as a hard disk drive, a removable memory, or a solid-state drive (e.g., flash memory or dynamic random access memory (DRAM)).

As shown in FIG. 3, a shielded twisted pair 350, indicated by a triple line, may connect the head-mounted display (HMD) controller 320 to the camera 304. In some examples, the battery 301 feeds through the head-mounted display (HMD) controller 320 to provide the direct current (DC) power to the shielded twisted pair 350 and the camera 304. In some examples, the shielded twisted pair 350 provides both power to the camera 304 and a communication link between the head-mounted display (HMD) controller 320 and the camera 304. In some examples, the head-mounted display (HMD) controller 320 may act as a battery management unit (BMU).

In the example in FIG. 3, the shielded twisted pair 350 forms a direct end-to-end connection between the head-mounted display (HMD) controller 320 and the camera 304. In some examples, instead of, or in addition to, the shielded twisted pair 350 between the head-mounted display (HMD) controller 320 and the camera 304, another shielded twisted pair may form a direct end-to-end connection between the head-mounted display (HMD) controller 320 and any one of, for example, display 310, illuminator(s) 308, or any one of sensors 312A-312D. In some examples, multiple shielded twisted pairs may form individual direct end-to-end connections between the head-mounted display (HMD) controller 320 and each component/subsystem in the near-eye display device 300 such that the head-mounted display (HMD) controller 320 may send control signals to, and receive data from, each of the components/subsystems in the near-eye display device 300. In other examples, a bus-like system similar to FIG. 1B may be used, rather than having multiple separate one-to-one shielded twisted pair connections throughout the near-eye display device 300.

In some examples, a component/subsystem connected by the shielded twisted pair 350 to the head-mounted display (HMD) controller 320 may be broken up and located in several locations in the near-eye display device 300. For example, the various sensors 312A-312D may form a single subsystem and be connected as an integrated subsystem through a single shielded twisted pair to the head-mounted display (HMD) controller 320. In some examples, each subsystem or component may be an individual printed circuit board disposed in or on the near-eye display device 300, where one or more of the individual printed circuit boards may be employed for multiple functions.

In other examples, one or more additional batteries may be disposed in the near-eye display device 300. In such examples, power load balancing may be employed by components/subsystems connected by a shielded twisted pair. For instance, another battery may be disposed within the other temple 306R of the near-eye display device 300 and electrically connected to the camera 304. In such an instance, load balancing may be maintained over the shielded twisted pair 350 connecting the camera 304 to the head-mounted display (HMD) controller 320 and battery 301.

FIG. 4 illustrates a block diagram of a sensor circuit board connected to an application processor circuit board by a shielded twisted pair, according to an example. As shown in FIG. 4, a sensor circuit board 410 having sensors 416 is connected via a shielded twisted pair 450 to an application processor circuit board 470 having application processor 476, where the shielded twisted pair 450 may include two wires 450A and 450B and a shielding layer 453. The application processor circuit board 470 may have a battery 479 for providing direct current (DC) power to the sensor circuit board 410 over the twisted shielded pair 450. The battery 479 may also provide power for the application processor circuit board 470.

In some examples, the application processor 476 in application processor circuit board 470 may control the sensor circuit board 410 and, more specifically, may both control and receive data from the sensors 416 on the sensor circuit board 410. In some examples, the application processor 476 may include at least one processor and may be connected to at least one non-transitory computer-readable storage medium storing instructions executable by the at least one processor. The application processor 476 may include multiple processing units, and those multiple processing units may further execute instructions in parallel. The at least one non-transitory computer-readable storage medium may be any memory, such as a hard disk drive, a removable memory, or a solid-state drive (e.g., flash memory or dynamic random access memory (DRAM)). In some examples, the sensors 416 on the sensor circuit board 410 may include any number of depth sensors, motion sensors, position sensors, inertial sensors, ambient light sensors, image sensors or cameras, etc.

In a similar manner to the electrical component/subsystem shown in FIG. 2, the sensor circuit board 410 may include a receiver 411, a transmitter 412, and a power converter 419, all electrically connected to the wires 450A and 450B. In some examples, the receiver 411, the transmitter 412, and the power converter 419 may also be electrically connected to the shielding layer 453 of the shielded twisted pair 450. In some examples, the communication circuits, i.e., the receiver 411 and the transmitter 412, are effectively isolated by capacitors 413 from the direct current (DC) power voltage being transmitted over the shielded twisted pair 450 from battery 479 in the application processor circuit board 470. In some examples, the power converter 419 is isolated by inductors 417 from the differential signalling being transmitted over the shielded twisted pair 450 by communication circuits in either the sensor circuit board 410 or the application processor circuit board 470. In such examples, the power converter 419 may receive direct current (DC) power over the twisted shielded pair 450 and may convert it for usage by the sensor circuit board 410.

Similarly, as shown in FIG. 4, the application processor circuit board 470 may include a receiver 471, a transmitter 472, and the battery 479, all electrically connected to the wires 450A and 450B. In some examples, the receiver 471, the transmitter 472, and the battery 479 may also be electrically connected to the shielding layer 453 of the shielded twisted pair. In some examples, the communication circuits, i.e., the receiver 471 and the transmitter 472, are effectively isolated by capacitors 473 from the direct current (DC) power voltage being transmitted over the shielded twisted pair 450 from battery 479. In some examples, the battery 479 is isolated by inductors 477 from the differential signalling being transmitted over the shielded twisted pair 450. In such examples, the battery 479 transmits direct current (DC) power over the twisted shielded pair 450 for usage by the sensor circuit board 410. The battery 479 may also provide power for the application processor circuit board 470.

In a similar manner to the electrical components/subsystems in FIG. 1A, differential signalling may be used by the application processor circuit board 470 and the sensor circuit board 410 to communicate over the shielded twisted pair 450. In such examples, a complementary pair of signals (i.e., having opposite polarity) are transmitted over the two separate wires 450A and 450B, thereby enabling binary signalling (i.e., only two symbols may be transmitted, commonly a 1 or a 0).

As shown in FIG. 4, in such examples, the application processor 476 on the application processor circuit board 470 may output parallel streams of data, control, and/or other signals for transmission to each of the sensors 416 on the sensor circuit board 410. In such examples, the parallel streams of data, control, and/or other signals from the application processor 476 may be input and converted into a serial stream of binary symbols by a serializer 474, and the serial stream of symbols may be input into the transmitter 472, which may transmit it, symbol by symbol, as a series of differential signals over the shielded twisted pair 450.

In such examples, the sensor circuit board 410 may receive the parallel streams of data, control, and/or other signals output from the application processor 476 as a series of differential signals over the shielded twisted pair 450. In such examples, the receiver 411 on the sensor circuit board may receive the differential signals over the wires 450A and 450B, and effectively turn it into a series of 1's and 0's, which may be provided to a deserializer 415, which may convert the series of received symbols back into parallel data streams. More specifically, in some examples, the deserializer 415 in the sensor circuit board 410 may convert the serial stream received over the shielded twisted pair 450 into parallel data streams, one for each of the sensors 416.

Similarly, in such examples, each of the sensors 416 on the sensor circuit board 410 may output a stream of data and/or other signals for transmission to the application processor 476 on the application processor circuit board 470. In such examples, the individual streams from each sensor 416 form parallel streams of data and/or other signals which may be input to the serializer 414 which converts them into a serial stream of symbols, which may be input into the transmitter 412, which may transmit the series, symbol by symbol, as differential signals over the shielded twisted pair 450. When, in such examples, the application processor circuit board 470 may receive the series of differential signals over the shielded twisted pair 450, the transmitter 472 may effectively turn the series of differential signals into a series of 1's and 0's, which may be provided to the deserializer 475, which may convert the complete series of received symbols back into parallel data streams. More specifically, the deserializer 475 in the application processor circuit board 470 may convert the serial stream received over the shielded twisted pair 450 into parallel data streams, each of which may correspond to one of the sensors 416, which are input into the application processor 476.

In examples using a serialization and deserialization (SERDES) scheme such as shown in FIG. 4, timing for communications may be set to one or more internal clocks and clock/timing signals. In other examples, a serialization and deserialization (SERDES or SerDes) scheme such as shown in FIG. 4 is not used, and/or no internal clock or timing signals are used. In some examples, the transmitters 412 and 472 and the receivers 411 and 471 may be implemented as amplifiers. In general, as would be understood by one of ordinary skill in the art, the various components of the sensor circuit board 410 and the application processor circuit board 470 may be implemented in and by any type of transistor logic comprised of, e.g., metal oxide semiconductors.

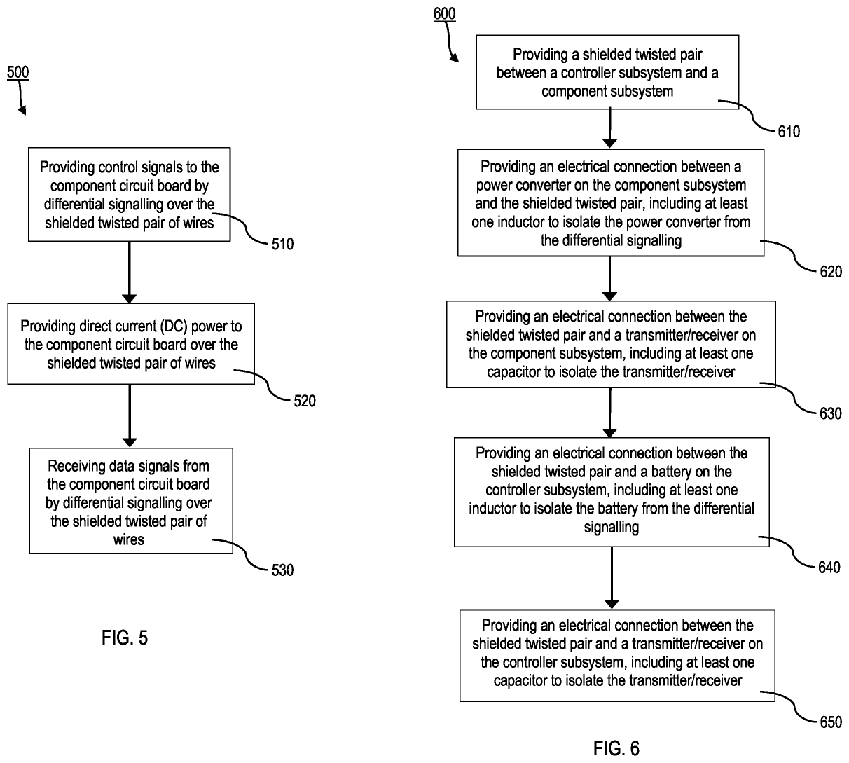

FIG. 5 illustrates a flow diagram of a method for an application processor in a controller subsystem to provide communication and power over a single shielded twisted pair of wires in a near-eye display device, according to some examples. The method 500 shown in FIG. 5 is provided by way of example and may only be one part of an entire process and/or the implementation of the interconnections between an application processor and a component circuit board. The method 500 may further omit parts of the process not germane to the present disclosure, as would be understood by one of ordinary skill in the art. Each block shown in FIG. 5 may further represent one or more steps, processes, methods, or subroutines, as would be understood by one of ordinary skill in the art. For the sake of convenience and ease of explanation, the description below in reference to FIG. 5 may refer to the controller subsystem 170 and the component subsystem 110 shown in FIG. 1A, although the method 500 is not limited in any way to the components and/or construction shown or described in reference to FIG. 1A.

At block 510, the application processor 176 of the controller subsystem 170 provides control signals by differential signalling over the shielded twisted pair of wires 150 to the component subsystem 110. In an example where the component subsystem 110 may be a sensor board, the control signals may be, for example, a command to start sensing, a command to stop sensing, a command to send data, a command to send a status report, etc.

At block 520, the battery 179 of the controller subsystem 170 provides direct current (DC) power over the shielded twisted pair of wires 150 to the component subsystem 110. At block 530, the application processor 176 of the controller subsystem 170 receives data signals via differential signalling over the shielded twisted pair of wires 150 from the component subsystem 110. In an example where the component subsystem 110 may be a sensor board, the data signals may be, for example, image data from an image sensor, position data from a position sensor, depth data from a depth sensor, motion data from a motion sensor, light data from a light sensor, etc.

FIG. 6 illustrates a flow diagram of a method for constructing an intersystem connection between circuit boards in a wearable display device, according to some examples. The method 600 shown in FIG. 6 is provided by way of example and may only be one part of an entire manufacturing process. The method 600 may further omit parts of the process not germane to the present disclosure, as would be understood by one of ordinary skill in the art. Each block shown in FIG. 6 may further represent one or more steps, processes, methods, or subroutines, as would be understood by one of ordinary skill in the art. For the sake of convenience and ease of explanation, the description below in reference to FIG. 6 may refer to the controller subsystem 170 and the component subsystem 110 shown in FIG. 1A, although the method 600 is not limited in any way to the components and/or construction shown or described in reference to FIG. 1A.

At block 610, a shielded twisted pair 150 is provided between the controller subsystem 170 and the component subsystem 110. In some examples, the shielded twisted pair 150 provides power to the component subsystem and a communication link between the controller subsystem 170 and the component subsystem 110 via differential signalling.

At block 620, an electrical connection is provided between the shielded twisted pair 150 and a power converter 119 on the component subsystem 110. In some examples, at least one inductor is provided in the electrical connection to isolate the power converter 119 from the differential signalling being transmitted over the shielded twisted pair 150.

At block 630, an electrical connection is provided between the shielded twisted pair 150 and the transmitter 112 and the receiver 111 on the component subsystem 110. In some examples. at least one capacitor is provided in the electrical connection to isolate the transmitter and the receiver from the power provided to the component subsystem 110 over the shielded twisted pair 150.

At block 640, an electrical connection is provided between the shielded twisted pair 150 and a battery 179 on the controller subsystem 170. In some examples, the electrical connection is provided with at least one inductor to isolate the battery 179 from the differential signalling.

At block 650, an electrical connection is provided between the shielded twisted pair 150 and a transmitter 172 and a receiver 171 on the controller subsystem 170. In some examples, the electrical connection is provided with at least one capacitor to isolate the transmitter 172 and the receiver 171 from the power provided by the battery 179.

According to examples, a system, a method, and/or apparatus for a universal intersystem connection using a twisted shielded pair are described herein. A method of constructing a system and/or apparatus for a universal intersystem connection using a twisted shielded pair is also described herein. A non-transitory computer-readable storage medium may have an executable stored thereon, which when executed instructs a processor to perform the methods described herein.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Claims:

1. A wearable display device, comprising:
a pair of wires shielded by a conductive layer;
a first electronic subsystem electrically connected by the pair of wires to a second electronic subsystem, the first electronic subsystem to:
transmit or receive direct current (DC) power through at least two of the pair of wires and the conductive layer to or from the second electronic subsystem; and
exchange communication data with the second electronic subsystem using differential signalling over the pair of wires; and
the second electronic subsystem electrically connected by the pair of wires to the first electronic subsystem, the second electronic subsystem to:
transmit or receive the direct current (DC) power through the at least two of the pair of wires and the conductive layer to or from the second electronic subsystem; and
exchange communication data with the first electronic subsystem using differential signalling over the pair of wires.

2. The wearable display device of claim 1, wherein the second electronic subsystem further comprises:
a battery to provide the direct current (DC) power over the at least two of the pair of wires and the conductive layer to the first electronic subsystem; and
an application processor to control the first electronic subsystem.

3. The wearable display device of claim 2, wherein the first electronic subsystem comprises:
a power converter to convert the direct current (DC) power received from the battery over the at least two of the pair of wires and the conductive layer; and
at least one component controlled by the application processor in the second electronic subsystem.

4. The wearable display device of claim 3, wherein the at least one component of the first electronic subsystem comprises an image sensor, a position sensor, an inertial sensor, depth sensor, a motion sensor, a light sensor, a projector, an illuminator, a processor, an input/output device, or display electronics.

5. The wearable display device of claim 3, wherein the first electronic subsystem further comprises:
at least two inductors, one for each of the pair of wires, the at least two inductors to isolate the power converter from the differential signalling sent over the pair of wires.

6. The wearable display device of claim 1, wherein:
one of a first wire, a second wire, or the conductive layer is to carry a first voltage; and
another one of the one of the first wire, the second wire, or the conductive layer is to carry a second voltage different from the first voltage.

7. The wearable display device of claim 1, wherein the first electronic subsystem comprises:
a transmitter electrically connected to the pair of wires to transmit the communication data over the pair of wires using differential signalling; and
a receiver electrically connected to the pair of wires to receive the communication data over the pair of wires using differential signalling.

8. The wearable display device of claim 7, wherein the first electronic subsystem further comprises:
a serializer connected to the transmitter, the serializer to receive symbols in parallel for communication by the first electronic subsystem over the pair of wires and to serialize the received symbols for transmission as one or more signals by the transmitter; and
a deserializer connected to the receiver, the deserializer to receive symbols in series from the receiver and to deserialize the received symbols.

9. The wearable display device of claim 7, wherein the first electronic subsystem further comprises:
at least two capacitors, one for each of the pair of wires, the at least two capacitors to isolate the transmitter and the receiver from the direct current (DC) power received over the pair of wires.

10. The wearable display device of claim 1, further comprising:
at least one other pair of wires shielded by another conductive layer to provide direct current (DC) power to the first electronic subsystem and to facilitate exchange of communication data using differential signalling between the first electronic subsystem and the second electronic subsystem.

11. The wearable display device of claim 1, further comprising:
a third electronic subsystem electrically connected by the pair of wires to the first electronic subsystem and the second electronic subsystem, the third electronic subsystem to:
transmit or receive the direct current (DC) power through the at least two of the pair of wires and the conductive layer; and
exchange communication data with at least one of the first electronic subsystem or the second electronic subsystem using differential signalling over the pair of wires.

12. The wearable display device of claim 1, wherein the wearable display device is an augmented reality (AR)/virtual reality (VR) head-mounted display (HMD).

13. A near-eye display device, comprising:
a battery;
a shielded twisted pair of wires electrically connected to the battery;
a first circuit board electrically connected to the shielded twisted pair of wires, the first circuit board comprising:
a power converter electrically connected to the shielded twisted pair of wires to convert direct current (DC) power received from the battery through the shielded twisted pair of wires to power the first circuit board;
a transmitter electrically connected to the shielded twisted pair of wires to transmit communication using differential signalling over the shielded twisted pair of wires; and
a receiver electrically connected to the shielded twisted pair of wires to receive communication using differential signalling from the shielded twisted pair of wires; and
a second circuit board electrically connected to the shielded twisted pair of wires, the second circuit board comprising:
a transmitter electrically connected to the shielded twisted pair of wires to transmit communication using differential signalling over the shielded twisted pair of wires;
a receiver electrically connected to the shielded twisted pair of wires to receive communication using differential signalling from the shielded twisted pair of wires.

14. The near-eye display device of claim 13, wherein the second circuit board comprises a controller of the first circuit board, and
the battery is electrically connected through the controller to the shielded twisted pair of wires.

15. The near-eye display device of claim 14, wherein the battery is disposed on the second circuit board.

16. The near-eye display device of claim 13, wherein the first circuit board further comprises at least one of an image sensor, a position sensor, an inertial sensor, depth sensor, a motion sensor, a light sensor, a projector, an illuminator, a processor, an input/output device, or display electronics.

17. The near-eye display device of claim 13, wherein the first circuit board further comprises:
a serializer connected to the transmitter to receive symbols in parallel for communication by the first circuit board over the shielded twisted pair of wires and to serialize the received symbols for transmission as one or more signals by the transmitter; and
a deserializer connected to the receiver to receive symbols in series from the receiver and to deserialize the received symbols.

18. The near-eye display device of claim 13, further comprising:
a third circuit board electrically connected to the shielded twisted pair of wires to receive direct current (DC) power received through the shielded twisted pair of wires for use by the third circuit board and to transmit and receive communication with at least one of the first circuit board or the second circuit board using differential signalling over the shielded twisted pair of wires.

19. The near-eye display device of claim 13, wherein the first circuit board further comprises:
at least two inductors, one for each of the shielded twisted pair of wires, the at least two inductors to isolate the power converter from the differential signalling sent over the shielded twisted pair of wires.

20. A method for constructing an intersystem connection between circuit boards in a wearable display device, comprising:
providing a shielded twisted pair of wires between a first circuit board and a second circuit board, the shielded twisted pair of wires to provide power to the first circuit board and to exchange communication data between the first circuit board and the second circuit board via differential signalling;
providing an electrical connection between the shielded twisted pair of wires and a power converter on the first circuit board with at least one inductor to isolate the power converter from the differential signalling;
providing an electrical connection between the shielded twisted pair of wires and a transmitter and a receiver on the first circuit board with at least one capacitor to isolate the transmitter and the receiver from the power provided to the first circuit board;
providing an electrical connection between the shielded twisted pair of wires and a battery on the second circuit board with at least one inductor to isolate the battery from the differential signalling; and
providing an electrical connection between the shielded twisted pair of wires and a transmitter and a receiver on the second circuit with at least one capacitor to isolate the transmitter and the receiver from the power provided by the battery.
